(19) United States
(12) Patent Application Publication
(10) Pub. No.: US 2020/0109958 A1
(43) Pub. Date: Apr. 9, 2020

(54) SYSTEMS AND METHODS FOR DETERMINING TARGET STATIONS

(71) Applicant: BEIJING DIDI INFINITY TECHNOLOGY AND DEVELOPMENT CO., LTD., Beijing (CN)

(72) Inventors: Xiaodong HUANG, Beijing (CN); Fenglei WANG, Beijing (CN)

(73) Assignee: BEIJING DIDI INFINITY TECHNOLOGY AND DEVELOPMENT CO., LTD., Beijing (CN)

(21) Appl. No.: 16/710,191

(22) Filed: Dec. 11, 2019

Related U.S. Application Data
(63) Continuation of application No. PCT/CN2017/088110, filed on Jun. 13, 2017.

(51) Int. Cl. G01C 21/34; G01C 21/36

(52) U.S. Cl. CPC G01C 21/3438; G06Q 2240/00; G01C 21/3617

(57) ABSTRACT

A system includes at least one computer-readable storage medium including a set of instructions for determining target stations for a region in an on-demand service; and at least one processor in communication with the computer-readable storage medium. When executing the set of instructions, the at least one processor is directed to: obtain electronic signals encoding road information associated with a region and a plurality of service starting points of historical service orders associated with the region; operate logic circuits in the at least one processor to cluster the plurality of service starting points into a plurality of clusters based on the service starting points and the road information; operate the logic circuits in the at least one processor to determine one service starting point as a candidate point for each of the plurality of clusters based on a popularity score at the service starting point.

### CROSS-REFERENCE TO RELATED APPLICATION

This application is a Continuation of International Application No. PCT/CN2017/088110, filed on Jun. 13, 2017, the entire content of which is hereby incorporated by reference.

### TECHNICAL FIELD

The present disclosure generally relates to technology field of on-demand service, and in particular, systems and methods for determining target stations for a region in the on-demand service.

### BACKGROUND

On-demand service, such as online taxi hailing service, has become more and more popular. A carpooling service in the online taxi hailing service may be more economic for both the passengers and the drivers. However, the transportation efficient may decrease since the driver may need to carry different passengers to different destinations. A more efficient carpooling arrangement method may be significant to promote service quality. A carpooling station may be used to improve the boarding efficient of the on-demand service. Different passengers included in a carpooling order may be recommended to reach to a same carpooling station for boarding. A target station including the carpooling station may be more general and used in goods transportation or goods/passenger transportation. Therefore, it is desirable to provide systems and methods for determining target stations.

### SUMMARY

According to some embodiments of the present disclosure, a system includes at least one computer-readable storage medium including a set of instructions for determining target stations for a region in an on-demand service; and at least one processor in communication with the computer-readable storage medium. When executing the set of instructions, the at least one processor is directed to: obtain electronic signals encoding road information associated with a region and a plurality of service starting points of historical service orders associated with the region; operate logic circuits in the at least one processor to cluster the plurality of service starting points into a plurality of clusters based on the service starting points and the road information; operate the logic circuits in the at least one processor to determine one service starting point as a candidate point for each of the plurality of clusters based on a popularity score at the service starting point, wherein the popularity score is associated with number of orders having service starting points near the service starting point; and operate the logic circuits in the at least one processor to determine a group of the candidate points from the plurality of candidate points as target stations based on the popularity score of each of the plurality of candidate points and a distance constraint.

When executing the set of instructions, the at least one processor is further directed to optimize the target stations to: obtain electronic signals encoding a plurality of actual carpooling points included in orders with a first target station, wherein the first target station belongs to the determined target stations; operate the logic circuits in the at least one processor to determine a convergent point of the plurality of actual carpooling points; operate the logic circuits in the at least one processor to determine a deviation between the convergent point and the first target station; and in response to determining that the deviation is greater than a first threshold, operate the logic circuits in the at least one processor to substitute the first target station with the convergent point.

To cluster the service starting points into a plurality of clusters based on the service starting points and the road information, the processor is further directed to: operate the logic circuits in the at least one processor to determine a region including a plurality of service starting points; operate the logic circuits in the at least one processor to determine a density of service starting points based an area of the region and a number of the plurality of service starting points included in the region; and in response to a determination that the density is greater than a second threshold, operate the logic circuits in the at least one processor to cluster the plurality of service starting points included in the region into a cluster.

To determine a service starting point as a candidate point, the processor is further directed to: in each cluster and for each road associated with the cluster, operate the logic circuits in the at least one processor to determine a service starting point in the road that has highest popularity score as a representative point; and operate the logic circuits in the at least one processor to determine the candidate point based on the representative points and traffic constraints included in the road information for each cluster.

The traffic constraints include at least one of: parking prohibition area including at least one of highway or viaduct; difficulty to arrive by an automobile; walking distance for passengers; and available parking time duration for drivers.

To determine the group of the candidate points as target stations, the processor is further directed to: operate the logic circuits in the at least one processor to determine a constrained area for each candidate point, wherein distances between points included in the constrained area and the candidate point of the constrained area satisfy a criteria; for each candidate point, operate the logic circuits in the at least one processor to compare the popularity score of the candidate point with the popularity scores of other candidate points in the constrained area; in response to determining that the popularity score of the candidate point is greater than that of all of the other candidate points in the constrained area, classify the candidate point into a first set and classify the other candidate points in the constrained area of the candidate point into a third set; in response to determining that the popularity score of the candidate point is not greater than all of other popularity scores of the other candidate points in the constrained area, classify the candidate point into a second set; and operate the logic circuits in the at least one processor to determine candidate points in the first set as target stations.

To determine the group of the candidate points as target stations, the processor is further directed to operate the logic circuits in the at least one processor to: obtain residual candidate points by obtaining candidate points that are in the second set and not in the third set; empty the second set; for each residual candidate point, compare popularity scores of the other residual candidate points in the constrained area of the residual candidate point with the popularity score of the residual candidate point; in response to determining that the popularity score of the residual candidate point is greater than all of other popularity scores of the other residual candidate points in the constrained area of the residual candidate point, classify the residual candidate point into the first set and classify the other residual candidate points in the constrained area of the residual candidate point into the third set; in response to determining that the popularity score of the residual candidate point is not greater than all of other popularity scores of the other residual candidate points in the constrained area of the residual candidate point, classify the residual candidate point into the second set; and determine candidate points in the first set as target stations.

To determine the constrained area for each candidate point, the processor is further directed to: operate the logic circuits in the at least one processor to segment a map of the region into a plurality of squares with a certain side length based on longitude and latitude; and for each candidate point, operate the logic circuits in the at least one processor to determine a square where the candidate point locates in and eight squares around the determined square as the constrained area of the candidate point.

To determine the group of the candidate points as target stations, the processor is further directed to: for each target station, operate the logic circuits in the at least one processor to assess whether there exist a barrier causes actual a walking distance within a predetermined area around the target station greater than a third threshold; and operate the logic circuits in the at least one processor to determine a candidate point in the third set and located in the barrier as the target station.

According to other embodiments of the present disclosure, a method for determining target stations for a region in an on-demand service includes: obtaining electronic signals encoding road information associated with a region and a plurality of service starting points of historical service orders associated with the region; operating logic circuits in the at least one processor to cluster the plurality of service starting points into a plurality of clusters based on the service starting points and the road information; operating the logic circuits in the at least one processor to determine one service starting point as a candidate point for each of the plurality of clusters based on a popularity score at the service starting point, wherein the popularity score is associated with number of orders having service starting points near the service starting point; and operating the logic circuits in the at least one processor to determine a group of the candidate points from the plurality of candidate points as target stations based on the popularity score of each of the plurality of candidate points and a distance constraint.

The method further includes: obtaining electronic signals encoding a plurality of actual carpooling points included in orders with a first target station, wherein the first target station belongs to the determined target stations; operating the logic circuits in the at least one processor to determine a convergent point of the plurality of actual carpooling points; operating the logic circuits in the at least one processor to determine a deviation between the convergent point and the first target station; and in response to determining that the deviation is greater than a first threshold, operating the logic circuits in the at least one processor to substitute the first target station with the convergent point.

The operating of the logic circuits to cluster the service starting points into a plurality of clusters includes: operating the logic circuits in the at least one processor to determine a region including a plurality of service starting points; operating the logic circuits in the at least one processor to determine a density of service starting points based an area of the region and a number of the plurality of service starting points included in the region; and in response to a determination that the density is greater than a second threshold, operating the logic circuits in the at least one processor to cluster the plurality of service starting points included in the region into a cluster.

The operating of the logic circuits to determine a service starting point as a candidate point includes: in each cluster and for each road associated with the cluster, operating the logic circuits in the at least one processor to determine a service starting point in the road that has highest popularity score as a representative point; and operating the logic circuits in the at least one processor to determine the candidate point based on the representative points and traffic constraints included in the road information for each cluster.

The traffic constraints include at least one of: parking prohibition area including at least one of highway or viaduct; difficulty to arrive by an automobile; walking distance for passengers; and available parking time duration for drivers.

The operating of the logic circuits to determine the group of the candidate points as target stations includes: operating the logic circuits in the at least one processor to determine a constrained area for each candidate point, wherein distances between points included in the constrained area and the candidate point of the constrained area satisfy a criteria; for each candidate point, operating the logic circuits in the at least one processor to compare the popularity score of the candidate point with the popularity scores of other candidate points in the constrained area; in response to determining that the popularity score of the candidate point is greater than that of all of the other candidate points in the constrained area, classify the candidate point into a first set and classify the other candidate points in the constrained area of the candidate point into a third set; in response to determining that the popularity score of the candidate point is not greater than all of other popularity scores of the other candidate points in the constrained area, classify the candidate point into a second set; and operating the logic circuits in the at least one processor to determine candidate points in the first set as target stations.

The operating of the logic circuits to determine the group of the candidate points as target stations further including: obtaining residual candidate points by obtaining candidate points that are in the second set and not in the third set; emptying the second set; for each residual candidate point, comparing popularity scores of the other residual candidate points in the constrained area of the residual candidate point with the popularity score of the residual candidate point; in response to determining that the popularity score of the residual candidate point is greater than all of other popularity scores of the other residual candidate points in the constrained area of the residual candidate point, classifying the residual candidate point into the first set and classify the other residual candidate points in the constrained area of the residual candidate point into the third set; in response to determining that the popularity score of the residual candidate point is not greater than all of other popularity scores of the other residual candidate points in the constrained area of the residual candidate point, classifying the residual candidate point into the second set; and determining candidate points in the first set as target stations.

The operating of the logic circuits to determine the constrained area for each candidate point includes: operating the logic circuits in the at least one processor to segment a map of the region into a plurality of squares with a certain side length based on longitude and latitude; and for each candidate point, operating the logic circuits in the at least one processor to determine a square where the candidate point locates in and eight squares around the determined square as the constrained area of the candidate point.

The operating of the logic circuits to determine the group of the candidate points as target stations includes: for each target station, operating the logic circuits in the at least one processor to assess whether there exist a barrier causes actual a walking distance within a predetermined area around the target station greater than a third threshold; and operating the logic circuits in the at least one processor to determine a candidate point in the third set and located in the barrier as the target station.

According to yet other embodiments of the present disclosure, a non-transitory processor-readable storage medium includes a set of instructions for determining target stations for a region in an on-demand service. When executed by at least one processor, the set of instructions directs the at least one processor to perform acts of: obtaining electronic signals encoding road information associated with a region and a plurality of service starting points of historical service orders associated with the region; operating logic circuits in the at least one processor to cluster the plurality of service starting points into a plurality of clusters based on the service starting points and the road information; operating the logic circuits in the at least one processor to determine one service starting point as a candidate point for each of the plurality of clusters based on a popularity score at the service starting point, wherein the popularity score is associated with number of orders having service starting points near the service starting point; and operating the logic circuits in the at least one processor to determine a group of the candidate points from the plurality of candidate points as target stations based on the popularity score of each of the plurality of candidate points and a distance constraint.

The set of instructions further directs the at least one processor to perform acts of: obtaining electronic signals encoding a plurality of actual carpooling points included in orders with a first target station, wherein the first target station belongs to the determined target stations; operating the logic circuits in the at least one processor to determine a convergent point of the plurality of actual carpooling points; operating the logic circuits in the at least one processor to determine a deviation between the convergent point and the first target station; and in response to determining that the deviation is greater than a first threshold, operating the logic circuits in the at least one processor to substitute the first target station with the convergent point.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a block diagram of an exemplary online platform for on-demand service according to some embodiments of the present disclosure;

FIG. 2 is a schematic diagram illustrating exemplary hardware and software components of a computing device according to some embodiments of the present disclosure;

FIG. 3 is a flowchart of an exemplary process for determining target stations for providing a target service according to some embodiments of the present disclosure;

FIG. 4 is a flowchart of an exemplary process for optimizing carpooling stations according to some embodiments of the present disclosure;

FIG. 5 is a flowchart of an exemplary process for naming carpooling stations according to some embodiments of the present disclosure;

FIG. 6A is a flowchart of an exemplary process for clustering boarding points according to some embodiments of the present disclosure;

FIG. 6B is a schematic diagram illustrating an example of clustering boarding points according to some embodiments of the present disclosure;

FIG. 7 is a flowchart of an exemplary process for determining candidate points according to some embodiments of the present disclosure;

FIG. 8A is a schematic diagram illustrating an example of distance constraint according to some embodiments of the present disclosure;

FIG. 8B is a flowchart of an exemplary process for performing distance constraint according to some embodiments of the present disclosure;

FIG. 9A is a flowchart of an exemplary process for determining a constrained area according to some embodiments of the present disclosure;

FIG. 9B is a schematic diagram of an example of determining a constrained area according to some embodiments of the present disclosure;

FIG. 10A is a flowchart of an exemplary process for releasing candidate points in determining carpooling stations according to some embodiments of the present disclosure;

FIG. 10B is a schematic diagram of an example of setting extra carpooling stations according to some embodiments of the present disclosure; and

FIG. 11 is a block diagram illustrating an exemplary processor according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprises,” “comprising,” “includes,” and/or “including” when used in this disclosure, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operations and functions of the related elements of structure and the combination of parts and economies of manufacture, may become more apparent upon consideration of the following description with reference to the accompanying drawing(s), all of which form part of this specification. It is to be expressly understood, however, that the drawing(s) are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order or simultaneously. Moreover, one or more other operations may be added to the flowcharts. One or more operations may be removed from the flowcharts.

Moreover, while the systems and methods disclosed in the present disclosure are described primarily regarding evaluating a user terminal, it should also be understood that this is only one exemplary embodiment. The system or method of the present disclosure may be applied to user of any other kind of on-demand service platform. For example, the system or method of the present disclosure may be applied to users in different transportation systems including land, ocean, aerospace, or the like, or any combination thereof. The vehicle of the transportation systems may include a taxi, a private car, a hitch, a bus, a train, a bullet train, a high speed rail, a subway, a vessel, an aircraft, a spaceship, a hot-air balloon, a driverless vehicle, or the like, or any combination thereof. The transportation system may also include any transportation system that applies management and/or distribution, for example, a system for sending and/or receiving an express. The application scenarios of the system or method of the present disclosure may include a webpage, a plug-in of a browser, a client terminal, a custom system, an internal analysis system, an artificial intelligence robot, or the like, or any combination thereof.

The service starting points in the present disclosure may be acquired by positioning technology embedded in a wireless device (e.g., the passenger terminal, the driver terminal, etc.). The positioning technology used in the present disclosure may include a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning technologies may be used interchangeably in the present disclosure. For example, the GPS-based method and the WiFi-based method may be used together as positioning technologies to locate the wireless device.

An aspect of the present disclosure relates to systems and methods for determining target stations for providing a target service in a region. For example, the target service may be carpooling service for goods and/or passengers and the target stations may be boarding points of the carpooling service. To this end, the systems and methods may first identify service starting points from historical service order records; and then select target stations from these service starting points so that the target stations are both popular enough among service users and enough far away from each other.

It should be noted that the present solution relies on collecting usage data of a user terminal registered with an online system, which is a new form of data collecting means rooted only in post-Internet era. It provides detailed information of a user terminal that could raise only in post-Internet era. In pre-Internet era, it is impossible to collect information of a user terminal such as its traveling routes, service starting points, destinations, etc. Online on-demand service, however, allows the online platform to monitor millions of thousands of user terminals' behaviors in real-time and/or substantially real-time, and then provide better service scheme based on the behaviors of the user terminals. Therefore, the present solution is deeply rooted in and aimed to solve a problem only occurred in post-Internet era.

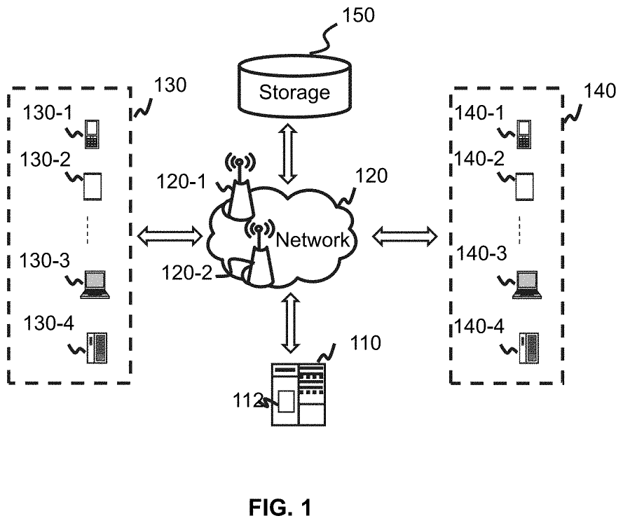

FIG. 1 is a block diagram of an exemplary system 100 as an online platform for on-demand service according to some embodiments of the present disclosure. For example, the on-demand service system 100 may be an online transportation service platform for transportation services such as taxi hailing, chauffeur service, express car, carpool, bus service, driver hire and shuttle service. System 100 may include a server 110, a network 120, a passenger terminal 130, a driver terminal 140, and a database 150. The server 110 may include a processing engine 112.

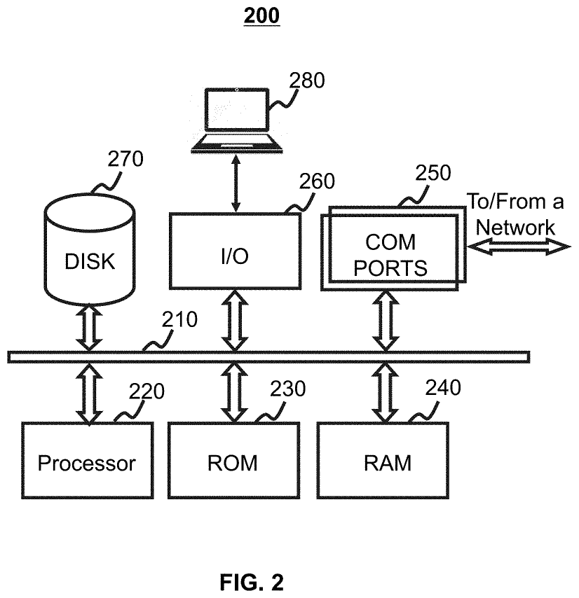

The server 110 may be configured to process information and/or data relating to a service request. For example, the server 110 may determine carpooling stations in a region. In some embodiments, the server 110 may be a single server, or a server group. The server group may be centralized, or distributed (e.g., the server 110 may be a distributed system). In some embodiments, the server 110 may be local or remote. For example, the server 110 may access information and/or data stored in passenger terminal 130, driver terminal 140, and/or database 150 via network 120. As another example, the server 110 may be directly connected to the passenger terminal 130, the driver terminal 140, and/or the database 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device having one or more components illustrated in FIG. 2 in the present disclosure.

In some embodiments, the server 110 may include a processing engine 112. The processing engine 112 may process information and/or data service request to perform one or more functions described in the present disclosure. For example, the processing engine 112 may boarding points of the user terminals 130. As another example, the processing engine 112 may cluster the boarding points and determine carpooling stations among the boarding points. In some embodiments, the processing engine 112 may include one or more processing engines (e.g., single-core processing engine(s) or multi-core processor(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components in the system 100 (e.g., the server 110, the passenger terminal 130, the driver terminal 140, and the database 150) may send and/or receive information and/or data to/from other component(s) in the system 100 via the network 120. For example, the server 110 may obtain/acquire service request from the passenger terminal 130 via the network 120. In some embodiments, the network 120 may be any type of wired or wireless network, or combination thereof. Merely by way of example, the network 120 may include a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth™ network, a ZigBee™ network, a near field communication (NFC) network, a global system for mobile communications (GSM) network, a code-division multiple access (CDMA) network, a time-division multiple access (TDMA) network, a general packet radio service (GPRS) network, an enhanced data rate for GSM evolution (EDGE) network, a wideband code division multiple access (WCDMA) network, a high speed downlink packet access (HSDPA) network, a long term evolution (LTE) network, a user datagram protocol (UDP) network, a transmission control protocol/Internet protocol (TCP/IP) network, a short message service (SMS) network, a wireless application protocol (WAP) network, a ultra wide band (UWB) network, an infrared ray, or the like, or any combination thereof. In some embodiments, the server 110 may include one or more network access points. For example, the server 110 may include wired or wireless network access points such as base stations and/or internet exchange points 120-1, 120-2, . . . , through which one or more components of the system 100 may be connected to the network 120 to exchange data and/or information.

The passenger terminal 130 may be used by a passenger to request an on-demand service. For example, a user of the passenger terminal 130 may use the passenger terminal 130 to send a service request for himself/herself or another user, or receive service and/or information or instructions from the server 110. In some embodiments, the term “user” and “passenger terminal” may be used interchangeably.

In some embodiments, the passenger terminal 130 may include a mobile device 130-1, a tablet computer 130-2, a laptop computer 130-3, a built-in device in a motor vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass, an Oculus Rift, a Hololens, a Gear VR, etc. In some embodiments, built-in device in the motor vehicle 130-4 may include an onboard computer, an onboard television, etc. Merely by way of example, the passenger terminal 130 may include a controller (e.g., a remote-controller).

In some embodiments, the passenger terminal 130 may be a wireless device with positioning technology for locating the position of the user and/or the passenger terminal 130. In some embodiments, the passenger terminal 130 may communicate with other positioning device to determine the position of the user, and/or the passenger terminal 130. In some embodiments, the passenger terminal 130 may send positioning information to the server 110.

In some embodiments, the driver terminal 140 may be similar to, or the same device as the passenger terminal 130. In some embodiments, the driver terminal 140 may be a wireless device with positioning technology for locating the position of the driver and/or the driver terminal 140. In some embodiments, the passenger terminal 130 and/or the driver terminal 140 may communicate with other positioning device to determine the position of the passenger, the passenger terminal 130, the driver, and/or the driver terminal 140. In some embodiments, the passenger terminal 130 and/or the driver terminal 140 may send positioning information to the server 110.

The database 150 may store data and/or instructions. In some embodiments, the database 150 may store data obtained/acquired from the passenger terminal 130 and/or the driver terminal 140. In some embodiments, the database 150 may store data and/or instructions that the server 110 may execute or use to perform exemplary methods described in the present disclosure. In some embodiments, the database 150 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (PEROM), an electrically erasable programmable ROM (EEPROM), a compact disk ROM (CD-ROM), and a digital versatile disk ROM, etc. In some embodiments, the database 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the database 150 may be connected to the network 120 to communicate with one or more components in the system 100 (e.g., the server 110, the passenger terminal 130, the driver terminal 140, etc.). One or more components in the system 100 may access the data or instructions stored in the database 150 via the network 120. In some embodiments, the database 150 may be directly connected to or communicate with one or more components in the system 100 (e.g., the server 110, the passenger terminal 130, the driver terminal 140, etc.). In some embodiments, the database 150 may be part of the server 110.

In some embodiments, one or more components in the system 100 (e.g., the server 110, the passenger terminal 130, the driver terminal 140, etc.) may have a permission to access the database 150. In some embodiments, one or more components in the system 100 may read and/or modify information related to the passenger, driver, and/or the public when one or more conditions are met. For example, the server 110 may read and/or modify one or more users' information after a service. As another example, the driver terminal 140 may access information related to the passenger when receiving a service request from the passenger terminal 130, but the driver terminal 140 may not modify the relevant information of the passenger.

In some embodiments, information exchanging of one or more components in the system 100 may be achieved by way of requesting a service. The object of the service request may be any product. In some embodiments, the product may be a tangible product, or an immaterial product. The tangible product may include food, medicine, commodity, chemical product, electrical appliance, clothing, car, housing, luxury, or the like, or any combination thereof. The immaterial product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used in the computer or mobile phone. The software and/or application may relate to socializing, shopping, transporting, entertainment, learning, investment, or the like, or any combination thereof. In some embodiments, the software and/or application relating to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle, etc.), a car (e.g., a taxi, a bus, a private car, etc.), a train, a subway, a vessel, an aircraft (e.g., an airplane, a helicopter, a space shuttle, a rocket, a hot-air balloon, etc.), or the like, or any combination thereof.

FIG. 2 is a schematic diagram illustrating exemplary hardware and software components of a computing device 200 on which the server 110, the passenger terminal 130, and/or the driver terminal 140 may be implemented according to some embodiments of the present disclosure. For example, the processing engine 112 may be implemented on the computing device 200 and configured to perform functions of the processing engine 112 disclosed in the present disclosure.

The computing device 200 may be used to implement an on-demand system for the present disclosure. The computing device 200 may implement any component of the on-demand service as described herein. In FIGS. 1-2, only one such computer device is shown purely for convenience purposes. One of ordinary skill in the art would understood at the time of filing of this application that the computer functions relating to the on-demand service as described herein may be implemented in a distributed fashion on a number of similar platforms, to distribute the processing load.

The computing device 200, for example, may include COM ports 250 connected to and from a network connected thereto to facilitate data communications. The computing device 200 may also include a central processor 220, in the form of one or more processors, for executing program instructions. The exemplary computer platform may include an internal communication bus 210, a program storage and a data storage of different forms, for example, a disk 270, and a read only memory (ROM) 230, or a random access memory (RAM) 240, for various data files to be processed and/or transmitted by the computer. The exemplary computer platform may also include program instructions stored in the ROM 230, the RAM 240, and/or other type of non-transitory storage medium to be executed by the processor 220. The methods and/or processes of the present disclosure may be implemented as the program instructions. The computing device 200 may also include an I/O component 260, supporting input/output between the computer and other components therein such as a user interface element 280. The computing device 200 may also receive programming and data via network communications.

Merely for illustration, only one processor 220 is described in the computing device 200. However, it should be note that the computing device 200 in the present disclosure may also include multiple processors, thus operations and/or method steps that are performed by one processor 220 as described in the present disclosure may also be jointly or separately performed by the multiple processors. For example, if in the present disclosure the processor 220 of the computing device 200 executes both step A and step B, it should be understood that step A and step B may also be performed by two different processors jointly or separately in the computing device 200 (e.g., the first processor executes step A and the second processor executes step B, or the first and second processors jointly execute steps A and B).

One of ordinary skill in the art would understand that when a component of the on-demand service system 100 and/or the computing device 200 performs, the component may perform through electrical signals and/or electromagnetic signals. For example, when a service requestor terminal 130 processes a task, such as making a determination, identifying or selecting an object, the requestor terminal 130 may operate logic circuits in its processor to process such task. When the service requestor terminal 130 sends out a service request to the server 110, a processor of the service requestor terminal 130 may generate electrical signals encoding the request. The processor of the service requestor terminal 130 may then send the electrical signals to an output port. If the service requestor terminal 130 communicates with the server 110 via a wired network, the output port may be physically connected to a cable, which further transmit the electrical signal to an input port of the server 110. If the service requestor terminal 130 communicates with the server 110 via a wireless network, the output port of the service requestor terminal 130 may be one or more antennas, which convert the electrical signal to electromagnetic signal. Similarly, a service provider terminal 130 may process a task through operation of logic circuits in its processor, and receive an instruction and/or service request from the server 110 via electrical signal or electromagnet signals. Within an electronic device, such as the service requestor terminal 130, the service provider terminal 140, and/or the server 110, when a processor thereof processes an instruction, sends out an instruction, and/or performs an action, the instruction and/or action is conducted via electrical signals. For example, when the processor retrieves or saves data from a storage medium, it may send out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

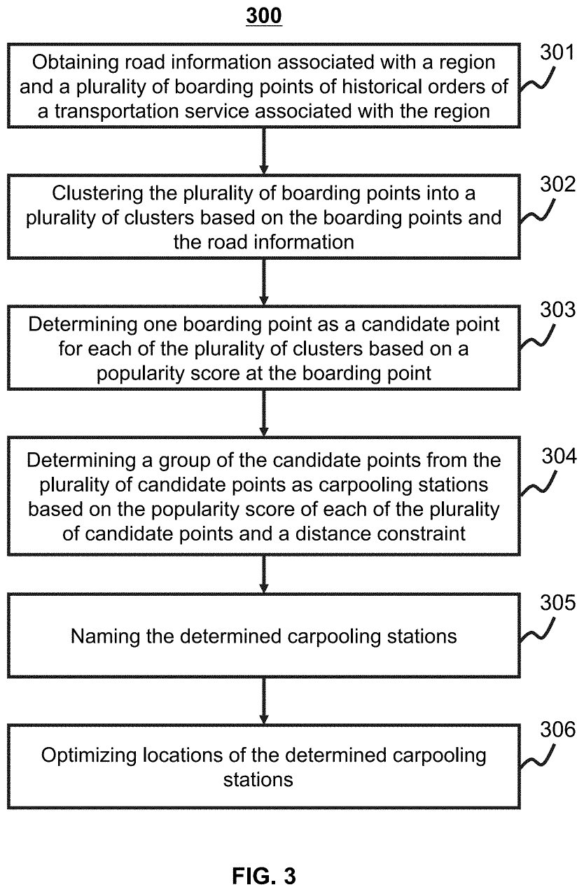

FIG. 3 is a flowchart of an exemplary process and/or method 300 for determining target stations for providing a target service according to some embodiments of the present disclosure.

In some embodiments, the target service may refer to gather goods and/or passengers at the target stations and provide transportation service for the goods and/or passengers. Purely for illustration purpose, the present disclosure may take passenger carpooling service as an example of the target service. Accordingly, the target service in this example may be boarding points of the carpooling service.

In some embodiments, the process may be implemented in the system 100 illustrated in FIG. 1. For example, the process 300 may be stored in the database 150 and/or the storage (e.g., the ROM 230, the RAM 240, etc.) as a form of instructions, and invoked and/or executed by the server 110 (e.g., the processing engine 112 in the server 110, or the processor 220 of the processing engine 112 in the server 110).

In 301, the processor 220 may obtain road information associated with a region and a plurality of boarding points of historical orders of a transportation service associated with the region.

In some embodiments, the database 150 and/or the storage (e.g., the ROM 230, the RAM 240, etc.) may store structured data encoding historical order information of the historical orders associated with the region, and the road information of the region. The historical order information may include various types of information of the historical orders associated with the region. For example, the various types of information may include boarding points, destinations, time information of the historical orders, or the like, or a combination thereof. As used herein, the boarding point may refer to a service starting point, where a driver pick up a passenger and/or goods. The time information may include waiting time by a driver, walking time by a passenger to reach to the boarding point, lasting time of an order (i.e., time between acceptance of a service request and completion of the service), or the like, or a combination thereof. In some embodiments, the region may be a predetermined geographic area such as a city, a town, a country, a street, one or more areas of a city (e.g., a business district of the city, an industrial park in the city, etc.), a state, or any other areas. The historical orders may refer to orders generated in a predetermined past time period. For example, orders generated in the past one year, one month, or one week may be considered as the historical orders. In some embodiments, the road information of the region may include various information of the roads located in the region. Exemplary information of the roads may include road grade, length, longitude/latitude information, ramp, barrier area, or the like, or a combination thereof. The road grade may include highway, main road, side road, or the like, or a combination thereof.

In 302, the processor 220 may cluster the boarding points into a plurality of clusters based on the boarding points and the road information.

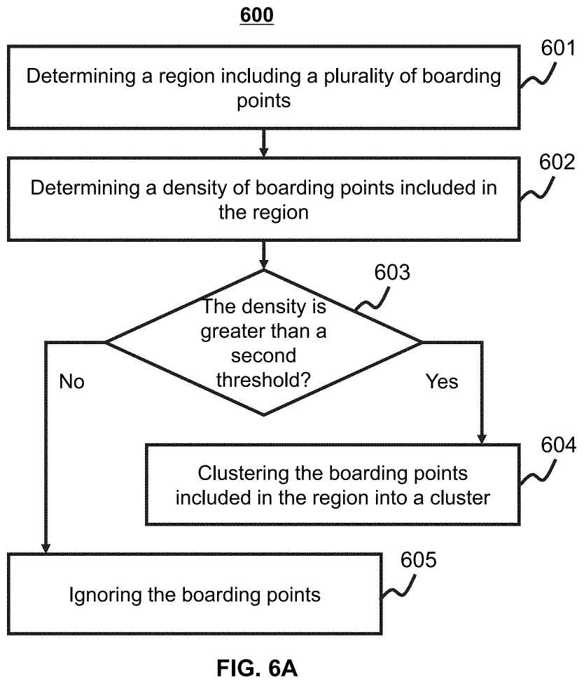

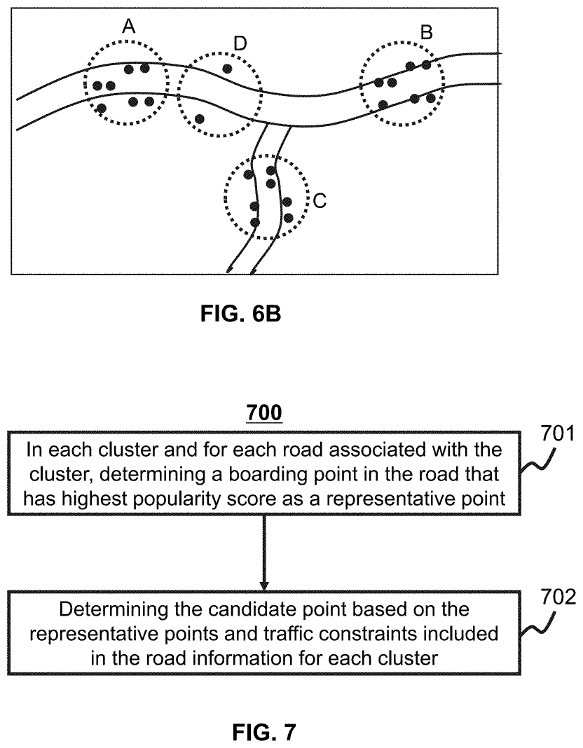

In the historical orders of a region, the boarding points of which may distribute along the roads locating in the region. For some reason, some of the boarding points may concentrate. For example, a plurality of boarding points may concentrate at a gate of a factory. Because when getting off work, workers of the factory may hail taxis at the gate of the factory. For another example, a plurality of boarding points may concentrate at a place of a side road close to a main road. Because the main road may be parking prohibition area. Passengers on the main road may have to get on the taxies at the side road. The processor 220 may identify the concentrated boarding points and further cluster them in to a plurality of clusters based on a clustering algorithm. Exemplary clustering algorithm may include partitioning method, hierarchical method, density-based method, grid-based method, model-based method, or the like, or a combination thereof. Details about the clustering may be disclosed elsewhere in the present disclosure (e.g. in the description of FIG. 6A and FIG. 6B). The plurality of boarding point clusters may represent areas where passengers are convenient to aboard.

In 303, the processor 220 may determine one boarding point as a candidate point for each of the clusters based on a popularity score at the boarding point.

In some embodiments, the candidate point may represent a boarding point cluster and further used to determine carpooling stations. The popularity score of a boarding point may be determined based on numbers of orders including the boarding point. In some embodiments, in a boarding point cluster, the boarding point with highest popularity score may be determined as the candidate point to represent cluster. In some embodiments, the candidate point may not be one of the boarding points in the cluster, but a new set point. For example, two boarding points may have a same highest popularity score. The processor 220 may set a point between the two boarding points as the candidate point.

In some embodiments, the candidate point determination may take road information at the cluster into consideration (not shown in the figure). For example, the boarding points at the place that not convenient (e.g. at highway, ramp, viaduct. etc.) for boarding may be firstly ignored before the candidate point determination. For another example, whether the road where boarding point locates is friendly to parking may be taken into consideration. Unlike usual carpooling which requires a vehicle to drop-off and/or pick-up a passenger and then leave, the driver may be allowed to wait more time at the carpooling station to pick up all the passengers recommended to board at the carpooling station. Therefore, roads convenient for parking may be more appropriate to serve (therefore be determined) as the candidate point. For example, when two boarding points may have a same highest popularity score in a cluster, but one of the two boarding points may locate at a main road and the other one may locate at a side road, the processor 220 may determine the boarding point at the side road as the candidate point.

In 304, the processor 220 may determine a group of the candidate points from the plurality of candidate points as carpooling stations based on the popularity score of each of the plurality of candidate points and a distance constraint.

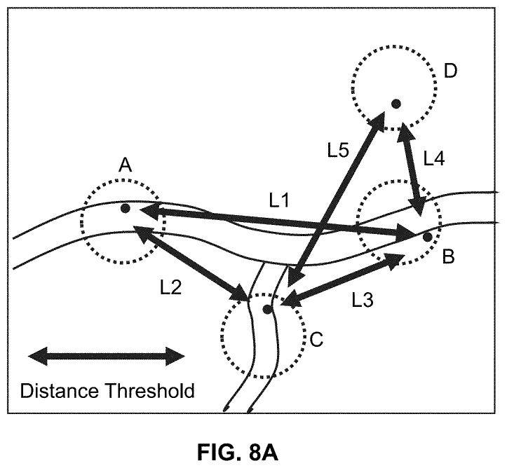

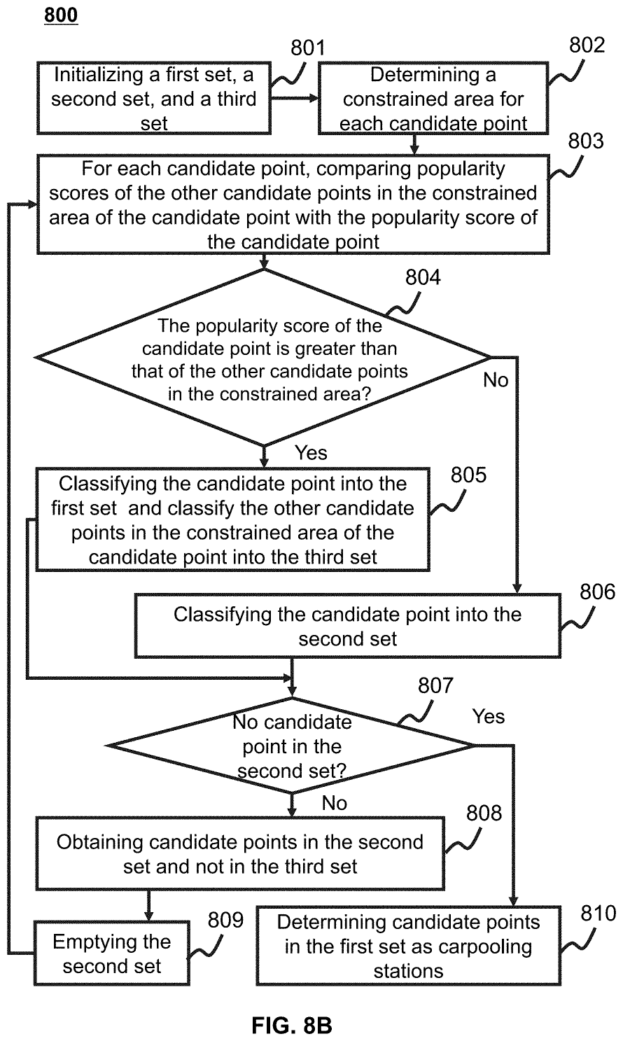

In some embodiments, not all the candidate points is suitable to serve as carpooling stations. Because in some active area, the distance between candidate points may be too short. There is no need to set too many carpooling stations in a relatively small area. In this case, candidate points with higher popularity score may be competitive. In some embodiments, the distance constraint of the carpooling station determination may be that distances between every two carpooling stations are required to greater than a distance threshold. Details about how to determine the carpooling stations based on the popularity score and distance constraint may be disclosed elsewhere in the present disclosure (e.g. in the description of FIG. 8A and FIG. 8B).

In 305, the processor 220 may name the determined carpooling stations in 304. In some embodiments, a carpooling station may be a boarding point. The processor 220 may name the carpooling station as the name of the boarding point.

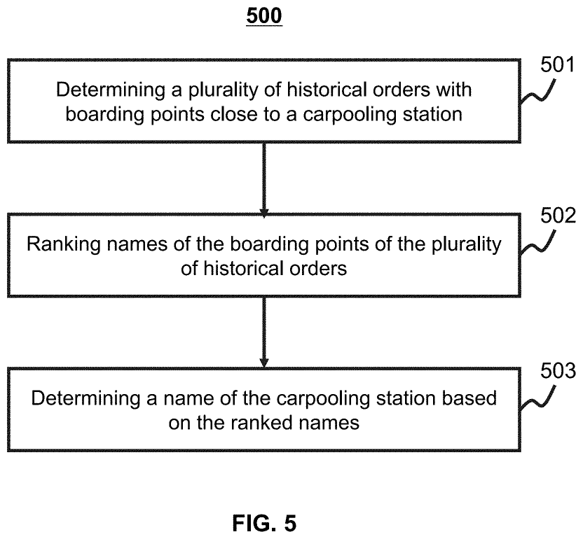

In some embodiments, a carpooling station may be a candidate point that set based on boarding points. The processor 220 may name the carpooling station based on boarding points close to the carpooling station. Details about the naming may be disclosed elsewhere in the present disclosure (e.g. in the description of FIG. 5).

In 306, the processor 220 may optimize locations of the determined carpooling stations.

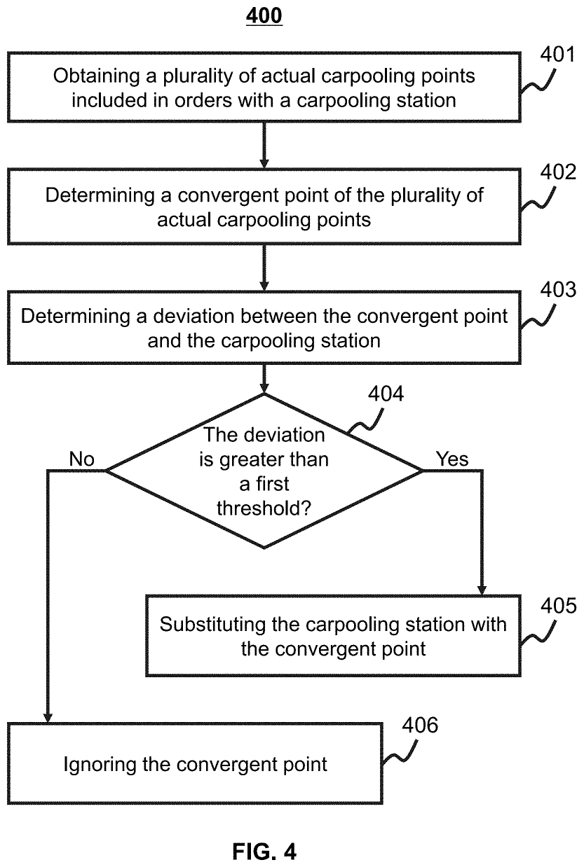

During actual use of the determined carpooling stations, deviations between actual boarding points and recommended carpooling stations may exist. For example, a carpooling station may locate at a main road. However, drivers may prefer to wait and pick up passengers recommended to aboard at the carpooling station at a side road close to the carpooling station. In this circumstance, the location of the carpooling station may need to be optimized and changed to the side road. Details about the optimizing may be disclosed elsewhere in the present disclosure (e.g. in the description of FIG. 4).

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step, a preprocessing step) may be added elsewhere in the exemplary process/method 300.

FIG. 4 is a flowchart of an exemplary process and/or method 400 for optimizing the carpooling stations according to some embodiments of the present disclosure. In some embodiments, the process 400 may be implemented in the system 100 illustrated in FIG. 1. For example, the process 400 may be stored in the database 150 and/or the storage (e.g., the ROM 230, the RAM 240, etc.) as a form of instructions, and invoked and/or executed by the server 110 (e.g., the processing engine 112 in the server 110, or the processor 220 of the processing engine 112 in the server 110).

In 401, the processor 220 may obtain a plurality of actual carpooling points included in orders with a carpooling station. In some embodiments, the carpooling station used herein may be one of the carpooling stations determined in 304. The carpooling station may be put into use for a certain period. The orders with the carpooling station may refer to historical orders in the certain period, which include the carpooling station recommended to passengers. The plurality of actual carpooling points may refer to actual boarding points of passengers in the orders. The actual boarding points may be different from the carpooling station for some reason.

In 402, the processor 220 may determine a convergent point of the plurality of actual carpooling points.

In some embodiments, the plurality of actual carpooling points may have a tendency to concentrate in a convergent point, i.e., in certain location or a small area. For example, the drivers may prefer to wait passengers at a parking lot instead of on a road. Because in this type of carpooling, the drivers may need to wait relatively longer time to pick up all passengers recommended to reach to the carpooling station. In this case, the actual carpooling points may tend to concentrate in the parking lot close to the recommended carpooling station. The convergent point may be used to represent the concentrated actual carpooling points. The processor 220 may determine the convergent point based on a distribution of the actual carpooling points. For example, the processor 220 may generate a popularity map (or a heat map) of actual carpooling point density in an appropriate area that includes the actual carpooling points. The processor 220 may determine a hottest spot (the most popular spot) in the popularity map as the convergent point.

In 403, the processor 220 may determine a deviation between the convergent point and the carpooling station.

The determination may be based on a map. The convergent point and the carpooling station may be located on the map. A distance that represents the deviation may be determined according to a plotting scale of the map. The distance may include straight-line distance and/or route distance (e.g., travel distance along a route). In some embodiments, the route distance may be different from the straight-line distance. For example, two points locating at two sides of a viaduct. The route distance may be longer than the straight-line distance between the two points. In some embodiments, the route distance may be used to represent the deviation between the convergent point and the carpooling station.

In 404, the processor 220 may assess whether the deviation is greater than a first threshold.

The first threshold may be a predetermined distance value that stored in the database 150 and/or the storage (e.g., the ROM 230, the RAM 240, etc.). In response to determining that the deviation is greater than the first threshold, the processor 220 may determine that the carpooling station needs to be optimized. Accordingly, the process 400 may proceed to 405. In response to determining that the deviation is not greater than the first threshold, the processor 220 may determine that the carpooling station is appropriate. Accordingly the process 400 may proceed to 406.

In 405, the processor 220 may substitute the carpooling station with the convergent point.

In this circumstance, the convergent point may be considered as more appropriate for drivers to wait passengers. The substituting may include rewrite the location of the carpooling station while maintaining other characteristics (e.g. name, popularity score, etc.) of the carpooling station. For example, the processor 220 may rewrite the longitude and latitude of the carpooling station based on the longitude and latitude of the convergent point.

In 406, the processor 220 may ignore the convergent point. In this case, the carpooling station may be considered as appropriate. The deviation is located in appropriate error because of random events.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step, a preprocessing step) may be added elsewhere in the exemplary process/method 400.

FIG. 5 is a flowchart of an exemplary process and/or method 500 for naming the carpooling stations according to some embodiments of the present disclosure. In some embodiments, the process 500 may be implemented in the system 100 illustrated in FIG. 1. For example, the process 500 may be stored in the database 150 and/or the storage (e.g., the ROM 230, the RAM 240, etc.) as a form of instructions, and invoked and/or executed by the server 110 (e.g., the processing engine 112 in the server 110, or the processor 220 of the processing engine 112 in the server 110).

In 501, the processor may determine a plurality of historical orders with boarding points close to a carpooling station.

In some embodiments, if the distances between the boarding points and the carpooling station is less than a predetermined distance, the boarding points may be considered as close to the carpooling station. For example, boarding points with distances to the carpooling station less than 50 meters may be considered as close to the carpooling station. The processor 220 may further obtain the order information of the determined historical orders. The order information may include names of the boarding points of the plurality of historical orders.

In 502, the processor 220 may rank the names of the boarding points of the plurality of historical orders.

In some embodiments, the ranking may be based on the popularity scores of the boarding points. For example, the names of the boarding points may be ranked by the processor 220 from highest popularity score to lowest popularity score. In some embodiments, the popularity score based ranking may further include some support ranking method. The construction of the names may affect the ranking result. For example, a name of the boarding point located in a crossroad is constructed based on the names of the two roads. However, crossroad may be less convenient for the drivers to parking for a time period comparing to a point at a side road. Therefore, the construction of the name of the boarding point at the crossroad may provide negative affection in the ranking of the names of the boarding points of the plurality of historical orders.

In step 503, the processor 220 may determine a name of the carpooling station based on the ranked names.

In some embodiments, the processor 220 may determine the first name in the ranked names as the name of the carpooling station. In some embodiments, the processor 220 may determine the name of the carpooling station based on top several names in the ranked names and the distances from boarding points to the carpooling station. For example, the processor 220 may determine top three names in the ranked names as appropriate for naming the carpooling station. Then the processor 220 may determine one of the three names with boarding point closest to the carpooling station as the name the carpooling station.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step, a preprocessing step) may be added elsewhere in the exemplary process/method 500.

FIG. 6A is a flowchart of an exemplary process and/or method 600 for clustering the boarding points according to some embodiments of the present disclosure.

In some embodiments, the process 600 may be implemented in the system 100 illustrated in FIG. 1. For example, the process 600 may be stored in the database 150 and/or the storage (e.g., the ROM 230, the RAM 240, etc.) as a form of instructions, and invoked and/or executed by the server 110 (e.g., the processing engine 112 in the server 110, or the processor 220 of the processing engine 112 in the server 110).

In 601, the processor 220 may determine a region including a plurality of boarding points.

In some embodiments, the region may be in a predetermined shape with constant area. For example, the region may be a circular with a certain diameter. In some other embodiments, the region determination may be based on the distribution of boarding points. The processor 220 may identify a certain number of boarding points and determine a region to surround them.

In 602, the processor 220 may determine a density based on an area of the region and a number of the plurality of boarding points included in the region.

The processor 220 may determine the area of the region based on map information. The processor 220 may count the boarding points to determine the number of boarding points in the region. In some embodiments, the density may be a density value, i.e., a ratio between the number of the plurality of boarding points and the area of the region. In some embodiments, the density determination may further take the popularity scores of the boarding points into consideration. For example, although a region includes fewer boarding points the popularity scores of the boarding points in the region can still be higher than other regions if orders with boarding points in the region is more than that in other regions. Therefore, the density may be determined by further multiplying the density value to an average popularity score of the boarding points.

In 603, the processor 220 may assess whether the density is greater than a second threshold. In response to determining that the density is greater than the second threshold, the process 600 may proceed to 604. In response to determining that the density is not greater than the threshold, the process 600 may proceed to 605.

In 604, the processor 220 may clustering the boarding points included in the region into a cluster. In some embodiments, the clustering may include labeling the boarding points. The processor 220 may allocate memory space to write cluster label data of the boarding points. Then, boarding points with same cluster label may be considered as in a same cluster.

In 605, the processor 220 may ignore the boarding points. In this step, the density of the region may be lower than the second threshold, which may mean that this region is not popular. Therefore, there is no need to set carpooling station in the region.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step, a preprocessing step) may be added elsewhere in the exemplary process/method 600.

FIG. 6B is a schematic diagram illustrating an example of clustering the boarding points according to some embodiments of the present disclosure.

As shown in the figure, a plurality of boarding points distribute along two roads. Four regions A, B, C, and D are determined by the processor 220. Each of the four regions include a plurality of boarding points. Density of the four regions may be further determined by the processor 220. The density of region D may less than the threshold since only two boarding points are included therein. Then the only two boarding points may be ignored by the processor 220. The boarding points may be further labeled with the name of the region. For example, the processor 220 may write a letter A in a corresponding memory space of the boarding points in region A.

FIG. 7 is a flowchart of an exemplary process and/or method 700 for determining candidate points according to some embodiments of the present disclosure.

In some embodiments, the process 700 may be implemented in the system 100 illustrated in FIG. 1. For example, the process 700 may be stored in the database 150 and/or the storage (e.g., the ROM 230, the RAM 240, etc.) as a form of instructions, and invoked and/or executed by the server 110 (e.g., the processing engine 112 in the server 110, or the processor 220 of the processing engine 112 in the server 110).

In 701, in each cluster and for each road associated with the cluster, the processor 220 may determine a boarding point in the road that has highest popularity score as a representative point. In some embodiments, the boarding points in a cluster may be distributed on one or more roads. Each of the roads may include more than one boarding points. The representative point may refer to one of the boarding points included in one road that with highest popularity score. The processor 220 may identify roads in a cluster and further identify boarding points located in each of the roads. For each road, the processor 220 may rank the boarding points based on their popularity scores and determine the highest one as the representative boarding point of the road.

In 702, the processor 220 may determine the candidate point based on the representative points and traffic constrains included in the road information for each cluster. For a cluster, one or more representative points may be determined in 701. In some embodiments, one of the representative points may be determined as the candidate point of the cluster and further used to campaign in the carpooling station determination. In some embodiments, the popularity scores of the representative points may be used to determine the candidate point. For example, the representative point with highest popularity score may be determined to be the candidate point of the cluster by the processor 220.

In some embodiments, traffic constraints of the roads may be taken in to consideration in the candidate point determination. The traffic constraints may include parking prohibition area, difficulty to arrive by an automobile, walking distance of passengers, available parking time duration for drivers, or the like, or a combination thereof. The parking prohibition area may include highway, viaduct, or the like. Theoretically, the popularity score of boarding points in the parking prohibition area should be low. However, some new set parking prohibition area may include boarding points with relatively high popularity score.

In some embodiments, some area may be difficult to arrive by an automobile. For example, a location inside a community may be available for automobiles with traffic permits. The walking distance for passengers may refer to an average distance for passengers in the region of the cluster walking to the representative points. For example, the processor 220 may identify historical orders in the region of the cluster and locate user terminals at the time of receiving the service requests. The locations of the user terminals 130 may be considered as locations of passengers. The processor 220 may further determine the distances between the locations of passengers to the each representative point. The processor 220 may further determine the average distance based on the distances on numbers of locations of passengers. Shorter average distance may mean more convenient for passengers to arrive. The available parking time duration for drivers may refer to whether the drivers can wait passengers for a time period. Longer time duration for availability of parking may provide positive affection in the candidate point determination.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step, a preprocessing step) may be added elsewhere in the exemplary process/method 700.

FIG. 8A is a schematic diagram illustrating an example of distance constraint according to some embodiments of the present disclosure.

As shown in the figure, candidate points have been determined by the processor 220 for the cluster A, B and C. As disclosed in the description of FIG. 1, the distances between each carpooling station should be greater than the distance threshold. In this figure, the distance L1 between the candidate point A and the candidate point B is greater than the distance threshold, while the distance L2 between the candidate point A and the candidate point C is less than the distance threshold, and the distance L3 between the candidate point B and the candidate point C is less than the distance threshold. Therefore, candidate points A and B may be determined as carpooling stations simultaneously. Candidate points A and C, or candidate points B and C may not be determined as carpooling stations simultaneously. If candidate point C is determined as a carpooling station since the popularity score of the candidate point C is the greatest in the three candidate points, both of the candidate points A and B may be ignored by the processor 220 (e.g., the processor 220 may removes candidate points A and B from its processing queue).

A distance L4 between a candidate point D and the candidate point B may less than the threshold. The popularity of candidate point D may be lower than that of the candidate point B. Since the candidate points A and B have been ignored, and the distance L5 between the candidate points D and C is greater than the threshold, the candidate point D may be maintained and further determined to be a carpooling station. In another word, whether to maintain candidate point D is based on whether to maintain candidate point B. Therefore, a distribution algorithm for preforming the distance constraint is disclosed in the description of FIG. 8B.

FIG. 8B is a flowchart of an exemplary process and/or method 800 for performing distance constraint according to some embodiments of the present disclosure.

In some embodiments, the process 800 may be implemented in the system 100 illustrated in FIG. 1. For example, the process 800 may be stored in the database 150 and/or the storage (e.g., the ROM 230, the RAM 240, etc.) as a form of instructions, and invoked and/or executed by the server 110 (e.g., the processing engine 112 in the server 110, or the processor 220 of the processing engine 112 in the server 110). In some embodiments, the process 800 may be performed with distributed computation since the server 110 may be a distributed system.

In 801, the processor 220 may initialize a first set, a second set and a third set. In some embodiments, the processor 220 may allocate memory space for the three sets to store data. The first set may be used to store data of candidate points that may be determined surely as carpooling stations. The second set may be used to store data of candidate points to be confirmed as carpooling stations. The third set may be used to store data of candidate points that may be determined surely not to be carpooling stations.

In 802, the processor 220 may determine a constrained area or each candidate point. In the process 800, each candidate point may be processed individually, which may make it possible to implement the process 800 on a distributed system. In some embodiments, the constrained area may be an area including the currently processed candidate point. The constrained area may include one or more other candidate points except the currently processed candidate point. The shape of the constrained area may include any geometric shape, such as circle, rectangle, square, etc. For example, to implement the distance constraint, distances between the carpooling stations should be less than the distance threshold. In this case, the constrained area may be a circle. The center of the circle may be the currently processed candidate point. And the diameter of the circle may be the distance threshold.

In 803, for each candidate point, the processor 220 may compare popularity scores of the other candidate points in the constrained area of the candidate point with the popularity score of the candidate point (also referred as currently processed candidate point). In some embodiments, the processor 220 may identify all candidate points in the constrained area and their popularity scores. The processor 220 may compare every popularity score of other candidate points with that of the currently processed candidate point.

In 804, the processor 220 may perform an assessment based on the comparison in 803. In response to determining that the popularity score of the currently processed candidate point is greater than all of other popularity scores of the other candidate points in the constrained area, the process 800 may proceed to 805. In response to determining that the popularity score of the currently processed candidate point is not greater than all of other popularity scores of the other candidate points in the constrained area, the process 800 may proceed to 806.

In 805, the processor 220 may classify the currently processed candidate point into the first set and classify the other candidate points in the constrained area into the third set. In the present disclosure, the classifying may include labeling the candidate point. For example, the processor 220 may allocate a memory space for the candidate point and write label data in the allocated memory space.

In 806, the processor 220 may classify the currently processed candidate point in to the second. It should be noted that the steps from 804 to 806 are implemented for each candidate point. After the 804 or 806, each candidate point has been processed.

In 807, the processor 220 may perform another assessment to determine whether the second set include any candidate points. In response to determining that there is no candidate point in the second set, the process 800 may proceed to 810. In response to determining that there is one or more candidate points in the second set, the process 800 may proceed to 808.

In 808, the processor 220 may obtain candidate points in the second set and not in the third set. In some embodiments, a candidate point may be classified into the second in the process of itself, but may be classified into the third set in a process of other candidate point, which means the candidate point has been surly determined not to be a carpooling station. In this step, the process 220 may obtain candidate points to be confirmed as carpooling stations and may be further processed with iteration method.

In 809, the processor 220 may emptying the second set. In some embodiments, the processor 220 may wipe label data of candidate points in the second set. After the 809, the process 800 may proceed to 803 to start an iteration.

The candidate points to be processed in 803 are the candidate points obtained in 808.

In 810, the processor 220 may determine the candidate points in the first set as carpooling stations. Since there is no candidate point in the second set, each candidate point has been surely determined to be or not to be a carpooling station. The determined carpooling station may satisfy the distance constraint.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step, a preprocessing step) may be added elsewhere in the exemplary process/method 800.

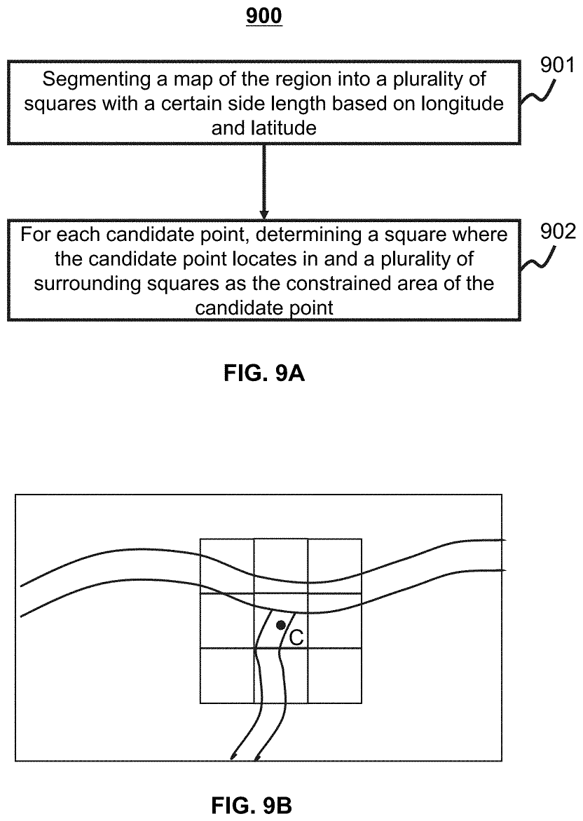

FIG. 9A is a flowchart of an exemplary process and/or method 900 for determining a constrained area according to some embodiments of the present disclosure.

In some embodiments, the process 900 may be implemented in the system 100 illustrated in FIG. 1. For example, the process 900 may be stored in the database 150 and/or the storage (e.g., the ROM 230, the RAM 240, etc.) as a form of instructions, and invoked and/or executed by the server 110 (e.g., the processing engine 112 in the server 110, or the processor 220 of the processing engine 112 in the server 110). In some embodiments, the process 900 may be performed with distributed computation since the server 110 may be a distributed system.

In 901, the processor 220 may segment a map of the region into a plurality of squares with a certain side length based on longitude and latitude. For example, as shown in the FIG. 9B, an area in the map has been segmented into nine squares with same side length. The side lengths of the squares may be parallel to longitude line and latitude line. The rest area in the map may also be segmented in this method and omitted here.

In 902, for each candidate point, the processor 220 may determine a square where the candidate point locates in and a plurality of surrounding squares (e.g., eight squares) as the constrained area of the candidate point. For example, as shown in the FIG. 9B, the processor 220 may identify a center square where the candidate point C locates in. Then the processor 220 may determine the eight squares around the center square. Then the processor 220 may determine the eight squares together with the center square as the constrained area of the candidate point C.

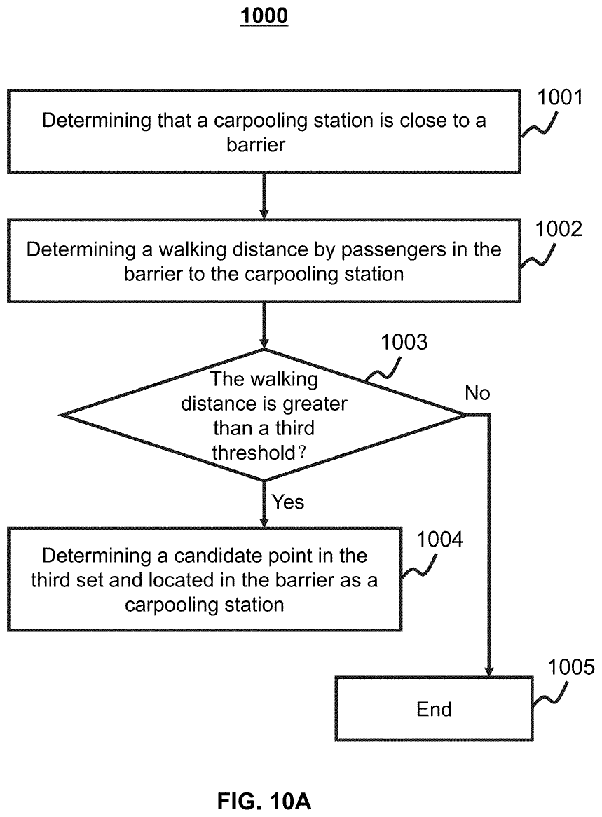

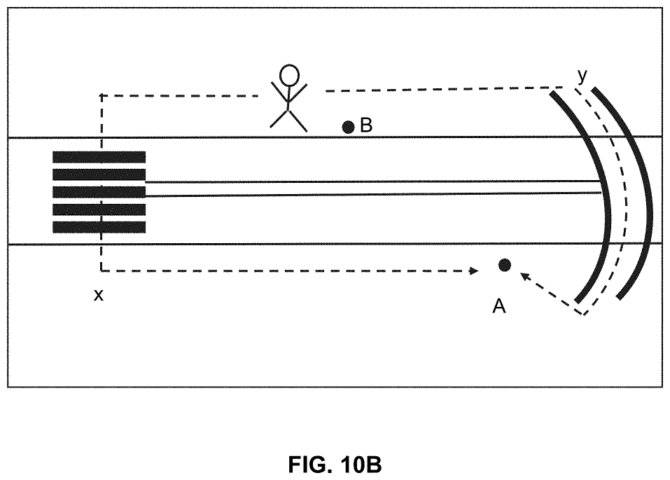

FIG. 10A is a flowchart of an exemplary process and/or method 1000 for releasing candidate points in determining carpooling stations according to some embodiments of the present disclosure.

In some embodiments, the process 1000 may be implemented in the system 100 illustrated in FIG. 1. For example, the process 1000 may be stored in the database 150 and/or the storage (e.g., the ROM 230, the RAM 240, etc.) as a form of instructions, and invoked and/or executed by the server 110 (e.g., the processing engine 112 in the server 110, or the processor 220 of the processing engine 112 in the server 110). In some embodiments, the process 1000 may be performed with distributed computation since the server 110 may be a distributed system.

After performing the distance constraint by the processor 220, distances between carpooling stations may be greater than a predetermined distance. The distance constraint may be performed based on straight-line distance without considering route distance. It may not be convenient for passengers if there is barrier around the carpooling stations. For example, as shown in the FIG. 10B, a carpooling station A may be set at one side of a viaduct. A passenger at the other side of the viaduct may need to walk a long distance though the zebra crossing to reach to the carpooling station A. In this case, an extra carpooling station B may be more convenient for the passenger. In some embodiments, the carpooling station B may be a candidate point that has been classified into the third set.

In some embodiments, the processor 220 may set a point cross the barrier corresponding to the carpooling station A. Referring back to FIG. 10A, the process 1000 is an example of setting the extra carpooling station B by releasing a candidate point in the third set.

In 1001, the processor 220 may determine a carpooling station is close to a barrier. In some embodiments, the processor 220 may identify the location of the carpooling station. Then the processor 220 may search barriers around the carpooling station. If the distance between a barrier and the carpooling station is less than a predetermined value, the processor 220 may determine that the carpooling station is close to a barrier.

In 1002, the processor may determine a walking distance by passenger in the barrier to the carpooling station.

In some embodiments, the walking distance may be a longest route from a point in the barrier to the carpooling station. For example, as shown in FIG. 10B, the passenger may reach to the carpooling station A through the zebra crossing or the bridge. The route through zebra may be designated as route x. The route through bridge may be designated as rout y. There may exist a middle point at the other side of the viaduct that from which to the carpooling station A, the distance of route x equal to the distance of route y. The route distance from the middle point to the carpooling station A may be considered as the longest route from a point in the barrier to the carpooling station.

In 1003, the processor 220 may perform an assessment to determine whether the walking distance is greater than a third threshold. The third threshold may be a distance that acceptable for passengers to walking to a carpooling station. In response to determining that the walking distance is greater than the third threshold, the process 1000 may proceed to 1005 to end the process. In response to determined that the walking distance is not greater than the third threshold, the process 1000 may proceed to 1004.

In 1004, the processor 220 may determine a candidate point in the third set and located in the barrier as a carpooling station. In some embodiments, the determination may be based on the longest route distance as disclosed above. For example, the processor 220 may determine the middle point according to the longest route. Then the processor 220 may determine a candidate point in the third set that closest to the middle point as a carpooling station.

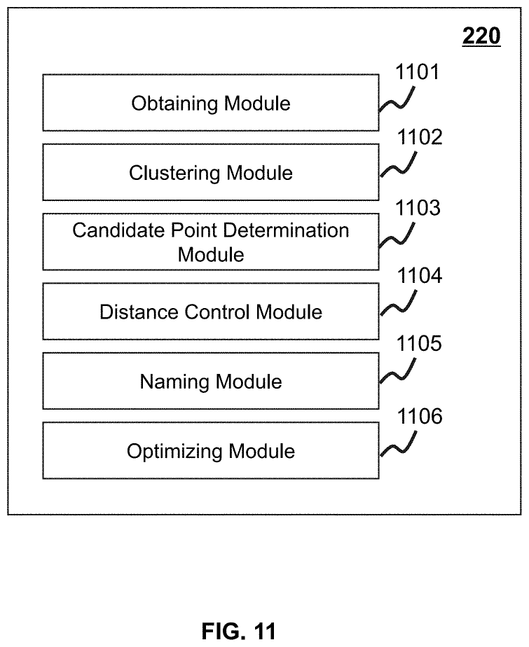

FIG. 11 is a block diagram illustrating an exemplary processor 220 according to some embodiments of the present disclosure. The processor 220 may include an obtaining module 1101, a clustering module 1102, a candidate point determination module 1103, a distance control module 1104, a naming module 1105, and an optimizing module 1106.

The obtaining module 1101 may be configured to obtain road information associated with a region and a plurality of boarding points of historical orders of a transportation service associated with the region. Details about the obtaining may be disclosed elsewhere in the present disclosure (e.g. in the description of 301).

The clustering module 1102 may be configured to cluster the boarding points into a plurality of clusters based on the boarding points and the road information. Details about the clustering may be disclosed elsewhere in the present disclosure (e.g. in the description of 302, the description of FIG. 6A and FIG. 6B).

The candidate point determination module 1103 may be configured to determine one boarding point as a candidate point for each of the clusters based on a popularity score at the boarding point. Details about the determination may be disclosed elsewhere in the present disclosure (e.g. in the description of 303, the description of FIG. 7).

The distance control module 1104 may be configured to determine a group of the candidate points from the plurality of candidate points as carpooling stations based on the popularity score of each of the plurality of candidate points and a distance constraint. Details about the distance controlling may be disclosed elsewhere in the present disclosure (e.g. in the description of 304, the description of FIG. 8A and FIG. 8B).

The naming module 1105 may be configured to name the determined carpooling stations. Details about the naming may be disclosed elsewhere in the present disclosure (e.g. in the description of 305, the description of FIG. 5).

The optimizing module 1106 may be configured to optimize locations of the determined carpooling stations. Details about the optimizing may be disclosed elsewhere in the present disclosure (e.g. in the description of 306, the description of FIG. 4).

The modules of the processor 220 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Any two of the modules may be combined into a single module, any one of the modules may be divided into two or more units.

The disclosure may also be provided as a computer-readable and/or processor-readable non-transitory storage medium having stored therein instructions, which may be used to program a computer system (or other electronic devices) to perform a process according to the disclosure. The process may be any one or more of the processes and/or methods as introduced in FIGS. 3-10A. For example, when the instructions are assessed by at least one processor, the instructions may direct the at least one processor to obtain road information associated with a region and a plurality of service starting points of historical service orders associated with the region; cluster the plurality of service starting points into a plurality of clusters based on the service starting points and the road information; determine one service starting point as a candidate point for each of the plurality of clusters based on a popularity score at the service starting point, wherein the popularity score is associated with number of orders having service starting points near the service starting point; determine a group of the candidate points from the plurality of candidate points as target stations based on the popularity score of each of the plurality of candidate points and a distance constraint; name the determined target stations; and optimize locations of the determined target stations. Details about the processes may be disclosed elsewhere in the present disclosure.

Here, a computer-readable medium includes any mechanism for storing or transmitting information in a form readable by a machine (e.g., a computer). For example, in some implementations, computer-readable media can be transitory or non-transitory. For example, non-transitory computer-readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer-readable media can include signals on networks, in connectors, conductors, optical fibers, circuits, any suitable media that is fleeting and devoid of any semblance of permanence during transmission, and/or any suitable intangible media.

The disclosure also relates to an apparatus for performing the operations herein. This apparatus may be specially constructed for the required purposes, or it may include a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step, a preprocessing step) may be added elsewhere in the exemplary process/method 1000.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “sending,” “receiving,” “generating,” “providing,” “calculating,” “executing,” “storing,” “producing,” “determining,” “obtaining,” “calibrating,” “recording,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The terms “first,” “second,” “third,” “fourth,” etc. as used herein are meant as labels to distinguish among different elements and may not necessarily have an ordinal meaning according to their numerical designation.

In some implementations, any suitable computer readable media can be used for storing instructions for performing the processes described herein. For example, in some implementations, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in connectors, conductors, optical fibers, circuits, and any suitable media that is fleeting and devoid of any semblance of permanence during transmission, and/or any suitable intangible media.

It should be noted that the piano equipped with the heat dissipation system in some specific embodiments is provided for the purposes of illustration, and not intended to limit the scope of the present disclosure. Apparently for persons having ordinary skills in the art, numerous variations and modifications may be conducted under the teaching of the present disclosure. However, those variations and modifications may not depart the protecting scope of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the present disclosure are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, inventive embodiments lie in less than all features of a single foregoing disclosed embodiment.

1. A system, comprising:
at least one computer-readable storage medium including a set of instructions for determining target stations for a region in an on-demand service; and
at least one processor in communication with the computer-readable storage medium, wherein when executing the set of instructions, the at least one processor is directed to:
obtain electronic signals encoding road information associated with a region and a plurality of service starting points of historical service orders associated with the region;
operate logic circuits in the at least one processor to cluster the plurality of service starting points into a plurality of clusters based on the service starting points and the road information;
operate the logic circuits in the at least one processor to determine one service starting point of the plurality of service starting points as a candidate point for each of the plurality of clusters based on a popularity score at the service starting point, wherein the popularity score is associated with number of orders having service starting points near the service starting point; and
operate the logic circuits in the at least one processor to determine a group of the candidate points from the plurality of candidate points as target stations based on the popularity score of each of the plurality of candidate points and a distance constraint.

2. The system of claim 1, the processor is further directed to optimize the target stations to:
obtain electronic signals encoding a plurality of actual carpooling points included in orders with a first target station, wherein the first target station belongs to the determined target stations;
operate the logic circuits in the at least one processor to determine a convergent point of the plurality of actual carpooling points;
operate the logic circuits in the at least one processor to determine a deviation between the convergent point and the first target station; and
in response to determining that the deviation is greater than a first threshold, operate the logic circuits in the at least one processor to substitute the first target station with the convergent point.

3. The system of claim 1, wherein to cluster the plurality of the service starting points into a-the plurality of clusters based on the service starting points and the road information, the processor is further directed to:
operate the logic circuits in the at least one processor to determine a region including a plurality of service starting points;
operate the logic circuits in the at least one processor to determine a density of the plurality of service starting points based on an area of the region and a number of the plurality of service starting points included in the region; and
in response to a determination that the density is greater than a second threshold, operate the logic circuits in the at least one processor to cluster the plurality of service starting points included in the region into a cluster.

4. The system of claim 1, wherein to determine thea service starting point of the plurality of service starting points as tithe candidate point, the processor is further directed to:
in each cluster and for each road associated with the cluster, operate the logic circuits in the at least one processor to determine a service starting point in the road that has highest popularity score as a representative point; and
operate the logic circuits in the at least one processor to determine the candidate point based on the representative points and traffic constraints included in the road information for each cluster.

5. The system of claim 4, wherein the traffic constraints include at least one of:
parking prohibition area including at least one of highway or viaduct;
difficulty to arrive by an automobile;
walking distance for passengers; or
available parking time duration for drivers.

6. The system of claim 1, wherein to determine the group of the candidate points as the target stations, the processor is further directed to:
operate the logic circuits in the at least one processor to determine a constrained area for each candidate point, wherein distances between points included in the constrained area and the candidate point of the constrained area satisfy a criteria;
for each candidate point, operate the logic circuits in the at least one processor to
compare the popularity score of the candidate point with the popularity scores of other candidate points in the constrained area;
in response to determining that the popularity score of the candidate point is greater than that of all of the other candidate points in the constrained area, classify the candidate point into a first set and classify the other candidate points in the constrained area of the candidate point into a third set; and
in response to determining that the popularity score of the candidate point is not greater than all of other popularity scores of the other candidate points in the constrained area, classify the candidate point into a second set; and
operate the logic circuits in the at least one processor to determine candidate points in the first set as target stations.

7. The system of claim 6, wherein to determine the group of the candidate points as the target stations, the processor is further directed to operate the logic circuits in the at least one processor to:
obtain residual candidate points by obtaining candidate points that are in the second set and not in the third set;
empty the second set;
for each residual candidate point,
compare popularity scores of the other residual candidate points in the constrained area of the residual candidate point with the popularity score of the residual candidate point;
in response to determining that the popularity score of the residual candidate point is greater than all of other popularity scores of the other residual candidate points in the constrained area of the residual candidate point, classify the residual candidate point into the first set and classify the other residual candidate points in the constrained area of the residual candidate point into the third set;
in response to determining that the popularity score of the residual candidate point is not greater than all of other popularity scores of the other residual candidate points in the constrained area of the residual candidate point, classify the residual candidate point into the second set; and
determine candidate points in the first set as target stations.

8. The system of claim 6, wherein to determine the constrained area for each candidate point, the processor is further directed to:
operate the logic circuits in the at least one processor to segment a map of the region into a plurality of squares with a certain side length based on longitude and latitude; and
for each candidate point, operate the logic circuits in the at least one processor to determine a square where the candidate point locates and eight squares around the determined square as the constrained area of the candidate point.

9. The system of claim 7, wherein to determine the group of the candidate points as the target stations, the processor is further directed to:
Preliminary Amendment
for each target station, operate the logic circuits in the at least one processor to assess whether there exist a barrier causes actual a an actual walking distance within a predetermined area around the target station greater than a third threshold; and
operate the logic circuits in the at least one processor to determine a candidate point in the third set and located in the barrier as the target station.

10. A method for determining target stations for a region in an on-demand service, comprising:
obtaining electronic signals encoding road information associated with a region and a plurality of service starting points of historical service orders associated with the region;
operating logic circuits in the at least one processor to cluster the plurality of service starting points into a plurality of clusters based on the service starting points and the road information;
operating the logic circuits in the at least one processor to determine one service starting point of the plurality of service starting points as a candidate point for each of the plurality of clusters based on a popularity score at the service starting point, wherein the popularity score is associated with number of orders having service starting points near the service starting point; and
operating the logic circuits in the at least one processor to determine a group of the candidate points from the plurality of candidate points as target stations based on the popularity score of each of the plurality of candidate points and a distance constraint.

11. The method of claim 10, further comprising:
obtaining electronic signals encoding a plurality of actual carpooling points included in orders with a first target station, wherein the first target station belongs to the determined target stations;
operating the logic circuits in the at least one processor to determine a convergent point of the plurality of actual carpooling points;
operating the logic circuits in the at least one processor to determine a deviation between the convergent point and the first target station; and
in response to determining that the deviation is greater than a first threshold, operating the logic circuits in the at least one processor to substitute the first target station with the convergent point.

12. The method of claim 10, wherein the operating of the logic circuits to cluster the service starting points into ache plurality of clusters includes:
operating the logic circuits in the at least one processor to determine a region including a plurality of service starting points;
operating the logic circuits in the at least one processor to determine a density of the plurality of service starting points based on an area of the region and a number of the plurality of service starting points included in the region; and
in response to a determination that the density is greater than a second threshold, operating the logic circuits in the at least one processor to cluster the plurality of service starting points included in the region into a cluster.

13. The method of claim 10, wherein the operating of the logic circuits to determine thee service starting point of the plurality of service starting points as thea candidate point includes:
in each cluster and for each road associated with the cluster, operating the logic circuits in the at least one processor to determine a service starting point in the road that has highest popularity score as a representative point; and
operating the logic circuits in the at least one processor to determine the candidate point based on the representative points and traffic constraints included in the road information for each cluster.

14. The method of claim 13, wherein the traffic constraints include at least one of:
parking prohibition area including at least one of highway or viaduct;
difficulty to arrive by an automobile;
walking distance for passengers; or
available parking time duration for drivers.

15. The method of claim 10, wherein the operating of the logic circuits to determine the group of the candidate points as the target stations includes:
operating the logic circuits in the at least one processor to determine a constrained area for each candidate point, wherein distances between points included in the constrained area and the candidate point of the constrained area satisfy a criteria;
for each candidate point, operating the logic circuits in the at least one processor to
compare the popularity score of the candidate point with the popularity scores of other candidate points in the constrained area;
in response to determining that the popularity score of the candidate point is greater than that of all of the other candidate points in the constrained area, classify the candidate point into a first set and classify the other candidate points in the constrained area of the candidate point into a third set; and
in response to determining that the popularity score of the candidate point is not greater than all of other popularity scores of the other candidate points in the constrained area, classify the candidate point into a second set; and
operating the logic circuits in the at least one processor to determine candidate points in the first set as target stations.

16. The method of claim 15, wherein the operating of the logic circuits to determine the group of the candidate points as the target stations further includes:
obtaining residual candidate points by obtaining candidate points that are in the second set and not in the third set;
emptying the second set;
for each residual candidate point,
comparing popularity scores of the other residual candidate points in the constrained area of the residual candidate point with the popularity score of the residual candidate point;
in response to determining that the popularity score of the residual candidate point is greater than all of other popularity scores of the other residual candidate points in the constrained area of the residual candidate point, classifying the residual candidate point into the first set and classify the other residual candidate points in the constrained area of the residual candidate point into the third set;
in response to determining that the popularity score of the residual candidate point is not greater than all of other popularity scores of the other residual candidate points in the constrained area of the residual candidate point, classifying the residual candidate point into the second set; and
determining candidate points in the first set as target stations.

17. The method of claim 15, wherein the operating of the logic circuits to determine the constrained area for each candidate point includes:
operating the logic circuits in the at least one processor to segment a map of the region into a plurality of squares with a certain side length based on longitude and latitude; and
for each candidate point, operating the logic circuits in the at least one processor to determine a square where the candidate point locates 4 and eight squares around the determined square as the constrained area of the candidate point.

18. The method of claim 16, wherein the operating of the logic circuits to determine the group of the candidate points as the target stations includes:
for each target station, operating the logic circuits in the at least one processor to assess whether there exist a barrier causes actual a an actual walking distance within a predetermined area around the target station greater than a third threshold; and
operating the logic circuits in the at least one processor to determine a candidate point in the third set and located in the barrier as the target station.

19. A non-transitory processor-readable storage medium, comprising a set of instructions for determining target stations for a region in an on-demand service, wherein when executed by at least one processor, the set of instructions directs the at least one processor to perform acts of:
obtaining electronic signals encoding road information associated with a region and a plurality of service starting points of historical service orders associated with the region;
operating logic circuits in the at least one processor to cluster the plurality of service starting points into a plurality of clusters based on the service starting points and the road information;
operating the logic circuits in the at least one processor to determine one service starting point of the plurality of service starting points as a candidate point for each of the plurality of clusters based on a popularity score at the service starting point, wherein the popularity score is associated with number of orders having service starting points near the service starting point; and
operating the logic circuits in the at least one processor to determine a group of the candidate points from the plurality of candidate points as target stations based on the popularity score of each of the plurality of candidate points and a distance constraint.

20. The non-transitory processor-readable storage medium of claim 19, wherein the set of instructions further directs the at least one processor to perform acts of:
obtaining electronic signals encoding a plurality of actual carpooling points included in orders with a first target station, wherein the first target station belongs to the determined target stations;
operating the logic circuits in the at least one processor to determine a convergent point of the plurality of actual carpooling points;
operating the logic circuits in the at least one processor to determine a deviation between the convergent point and the first target station; and
in response to determining that the deviation is greater than a first threshold, operating the logic circuits in the at least one processor to substitute the first target station with the convergent point.
